(19) United States
(12) Patent Application Publication
(10) Pub. No.: US 2007/0139727 A1
(43) Pub. Date: Jun. 21, 2007

(54) System, method, and apparatus for automated imaging of a book

(76) Inventors: Sarasin Booppanon, Bangkok (TH); Jackrit Suthakorn, Bangkok (TH)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 11/311,488

(22) Filed: Dec. 20, 2005

(51) Int. Cl. H04N 1/04

(52) U.S. Cl. 358/474; 358/449

(57) ABSTRACT

Acquiring images of sequential pages of a book includes first and second transparent grippers for holding the pages of the book in place during scanning, while not inhibiting scanning of the content of the pages located underneath the grippers. A scanner is moveable across opened pages of the book for acquiring images of the opened pages. For turning to the next page, the first gripper disengages, and a page lifter lifts the first page for turning the first page. The first gripper engages a second page underneath the first page. The scanner moves over the second page, contacts the reverse side of the lifted first page, and completes turning of the first page. The second gripper contacts and grips the now-turned first page, and the scanner continues to pass over and scan the reverse side of the first page. For adjusting to various sizes of books, the range of movement of the scanner is limited by sensors that may be mounted on the grippers and that are movable toward and away from the center of the apparatus.

### BACKGROUND OF THE INVENTION

1. Field of the Invention

The invention relates generally to an automated system, method and apparatus for scanning the pages of a book or other bound document. More particularly, the invention relates to a system, method, and apparatus for sequentially scanning and turning the pages of an open book in an automated process for acquiring digital images of the pages of the book.

2. Description of the Related Art

At present, a process of copying all or a portion of a book or bound document is typically performed by using a photocopier. Users can reproduce a book by first opening the book to a desired page to be copied, placing the book on top of the photocopier with the page of the book facing down, and then photocopying that page. To copy more pages, it is then necessary to lift the book, turn to the next page, and then place the book back on the photocopier to make the next copy. If it is necessary to copy many pages of the book, this process can become quite tedious.

Additionally, most photocopiers today have document feeders that are capable of sequentially feeding multiple pages into the photocopier for copying a document. An unbound document can be automatically fed to a photocopier by the document feeder, and be photocopied sequentially, thereby speeding up the copying process. However, document feeders currently on the market are unable to assist in the copying of a book or bound document. Users still have to stand in front of the machine and copy the book page by page.

Furthermore, the current technology of document reproduction has been enhanced by the development of scanners that take an image of a printed page and save the result in a computer memory or other electronic storage device in the form of electronic data. This data can be in the format of a computer file, which possesses many advantages over a printed format. Users can choose to print the data out as a printed page, save the data for later use, easily transfer the data from one computer storage medium to another, convert the data to text usable in a word processing program, such as by optical character recognition (OCR), or the like. This scanning process may be carried out by a photocopier, a stand-alone scanner, a combination scanner/printer, a digital imager, and similar devices, many of which also have automatic document feeders. However, when it comes to scanning a book or other bound document, users still have to monitor the whole process and manually turn pages until all the desired pages have been scanned.

Additionally, the prior art includes several devices for scanning or photographing the pages of a book, and then automatically turning to the next the page of the book for scanning or photographing the next page. For the most part, these prior art devices are bulky complex machines with a large price tag that makes them prohibitive for many users who would otherwise like to have such a book imaging capability. Accordingly, a need exists for a compact, reliable and inexpensive device, method and system for automatically acquiring images of the pages of a book.

### BRIEF SUMMARY OF THE INVENTION

An object of the invention is to automate the process for creating a copy of a book, whereby a user is able to place a book in the apparatus of the invention, and obtain electronic images or copies of the pages of the book by use of the easily-portable automated apparatus. As referred to herein, a “book” may include books, magazines, periodicals, journals, notebooks, and other bound or semi-bound documents, articles, publications, collections, pages, or the like that are either permanently or temporarily connected or bound at one edge, and all other equivalents.

Under one aspect, the invention is an automatic book scanning, imaging, or copying apparatus that has a book-receiving surface for receiving a book. The book to be imaged is placed on the book-receiving surface, and the apparatus sequentially scans and turns the pages of the book. The apparatus includes a movable scanner that moves over the pages to be imaged for acquiring an image thereof, and a page lifter which automatically lifts the pages of the book for turning to the next sequential page to be imaged.

Under yet another aspect, the book is held within the book-receiving surface by a retaining mechanism including first and second adjustable, transparent, automated hold down grippers. One hold down gripper is located on each side of the book-receiving surface for pressing down against the pages of the book to maintain the book and the pages being scanned in a fixed position during imaging and page turning. The hold down grippers are transparent so that even if they cover portions of the content of the page to be scanned, the scanner can still obtain the full image of each page.

Under an additional aspect, the page lifter includes a pivotally-mounted arm having a page seizing end. As the arm rotates down and up, the end seizes a top page of the book, so that the edge of the page is lifted. The scanner is then able to move between the lifted page and the next page for completing turning the opened pages of the book to the next two pages, while simultaneously scanning the next two pages.

Under a further aspect, the scanning assembly comprises a scanning housing and scanner installed within vertical slots within a carriage that moves the scanner back and forth within the apparatus. The scanner is used to image the open pages of the book as it passes over the open pages, and is free to move up and down over the contour of the book, by being movably retained within the vertical slots of the carriage.

These and other features and advantages of the present invention will become apparent to those of ordinary skill in the art in view of the following detailed description of the preferred embodiments.

### BRIEF DESCRIPTION OF THE DRAWINGS

The accompanying drawings, in conjunction with the general description given above, and the detailed description of the preferred embodiments given below, serve to illustrate and explain the principles of the preferred embodiments of the best mode of the invention presently contemplated.

FIGS. 1a-1b illustrate an automatic book imaging apparatus of the invention according to a first embodiment.

FIG. 2 illustrates an enlarged view of the apparatus of FIG. 1 with the outer shroud removed.

FIG. 3 illustrates a perspective view of the apparatus of FIG. 2, with a book placed in the device and the scanning assembly traversed to the opposite side of the apparatus.

FIG. 4 illustrates the function of the transparent grippers of the invention.

FIG. 5 illustrates an enlarged cut-away view of a transparent gripper of the invention.

FIG. 6a illustrates an enlarged view of the scanning assembly and carriage of the invention.

FIG. 6b illustrates a reverse-side view of the scanning assembly and carriage of FIG. 4a.

FIG. 7a illustrates the apparatus of the invention prior to placement of a book into the book-receiving surface.

FIG. 7b illustrates the embodiment of FIG. 7a with a book to be scanned placed in the book-receiving surface and the grippers in the up position, prior to longitudinal adjustment of the grippers.

FIG. 7c illustrates the embodiment of FIG. 7a with the grippers in the gripping position and the scanning assembly in the starting position, prior to scanning of the first two pages.

FIG. 7d illustrates the embodiment of FIG. 7a with the scanner making a first pass over the first two pages of the book.

FIG. 7e illustrates the embodiment of FIG. 7a with the scanner having completed scanning of the first two pages.

FIG. 7f illustrates the embodiment of FIG. 7a with the scanning assembly returned to the starting position, the first gripper disengaged, and the page lifter beginning to lift the top page for turning.

FIG. 7g illustrates the embodiment of FIG. 7a with a page lifted, the first gripper re-engaged, and the scanner scanning the fourth page of the book while moving under the lifted page.

FIG. 7h illustrates the embodiment of FIG. 7a with the scanner completing turning of the page, the second gripper disengaged, and beginning scanning of the third page, which is the reverse side of the second page.

FIG. 7i illustrates the embodiment of FIG. 7a with the second gripper re-engaged, and the scanner completing scanning of the third page.

FIG. 7j illustrates the embodiment of FIG. 7a with the scanner returned to the starting position in preparation for scanning the next two pages of the book.

### DETAILED DESCRIPTION OF THE INVENTION

In the following detailed description of the invention, reference is made to the accompanying drawings which form a part of the disclosure, and, in which are shown by way of illustration, and not of limitation, specific embodiments by which the invention may be practiced. In the drawings, like numerals describe substantially similar components throughout the several views.

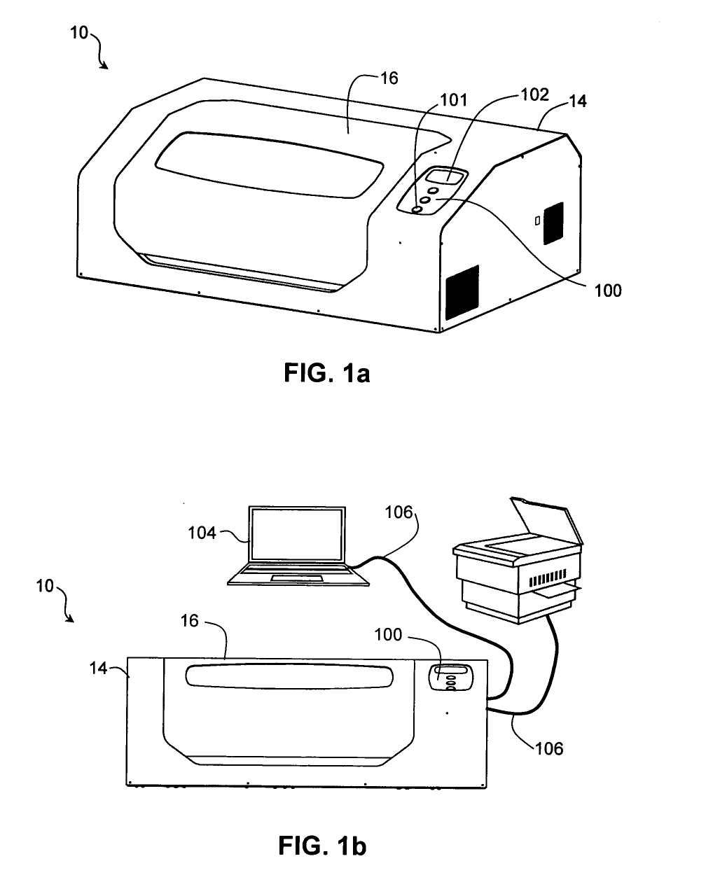

FIG. 1a illustrates a perspective view of an exemplary embodiment of the portable automatic book imaging apparatus 10 of the invention for digital scanning of a book, while FIG. 1b illustrates a front view of apparatus 10. Apparatus 10 includes an outer shroud 14 and closeable lid 16 constructed of plastic, sheet metal, or the like. Apparatus 10 may be controlled via a control panel 100, which may include various control buttons 101 and a display 102, and which may further contain a processor, memory and software (not shown) for controlling and operating the functions of apparatus 10, and/or for storing scanned images of pages of a book. Additionally or alternatively, apparatus 10 may be connected to an information processing device 104, such as a personal computer, PDA, or work station, via a connection 106, such as a USB connection, IEEE 1394 connection, network connection, wireless connection, or similar means. Information processing device 104 may have software for controlling apparatus 10, and a memory and storage for receiving scanned images of a book.

The use to which the images obtained using apparatus 10 may be applied is limited only by the software used to process the images, and may include the use of OCR software for reformatting the book or for audio playback of the book, word processing software for applying or editing text from the book, e-book viewing software for displaying the book on a reading device, archiving and database software for making the information in the book available to search engines, and the like. Further, apparatus 10 may be coupled to a printer or photocopier 108, either directly, or via connection 106 for making immediate copies of pages of a book. Other applications of apparatus 10 of the invention and the digital information obtained from its use will be apparent to those skilled in the art.

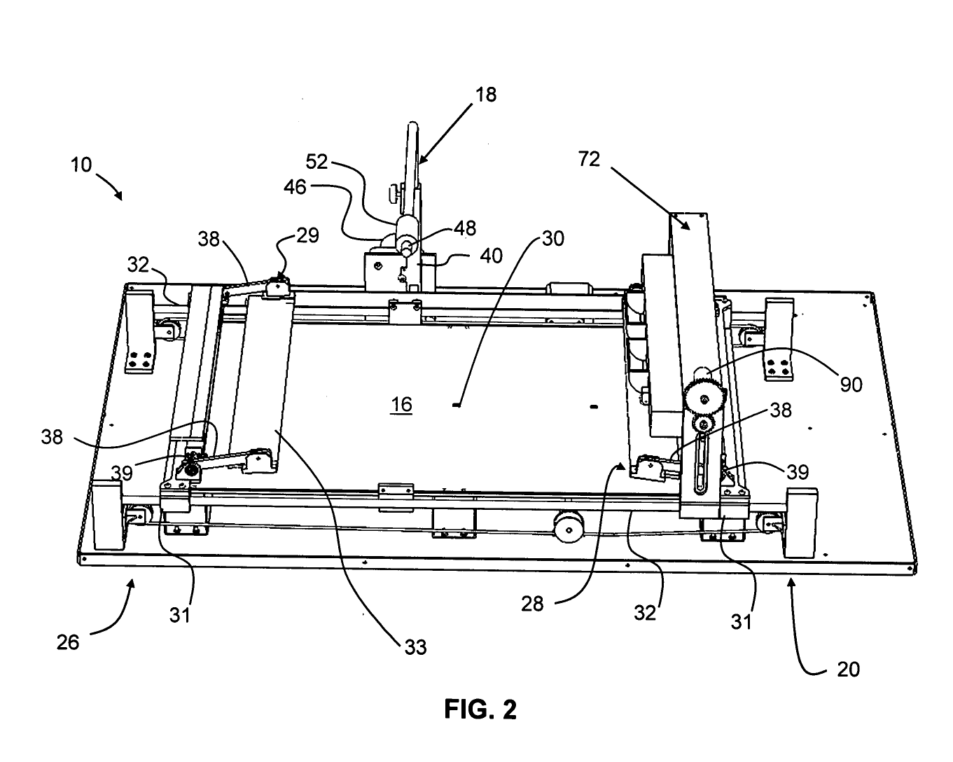

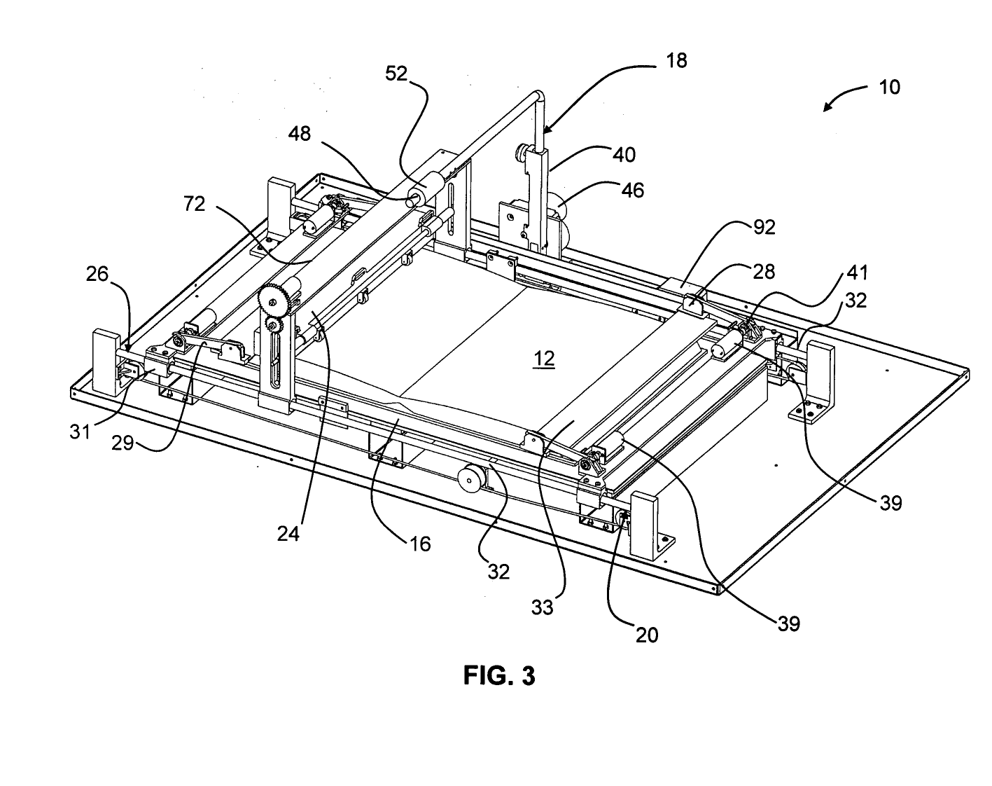

FIGS. 2 and 3 illustrate the apparatus of FIGS. 1a-1b with outer shroud 14 removed to better illustrate the inner mechanisms of the invention. FIG. 2 illustrates apparatus 10 before placement of a book into the apparatus, while FIG. 3 illustrates a book 12 placed into apparatus 10, and with a scanning assembly 24 moved to the opposite end of apparatus 10, as compared with the view of FIG. 2. A book-receiving surface 16 is a surface within the center of apparatus 10 able to receive book 12 in an open condition. A page lifter 18 is located near the center of apparatus 10 for lifting pages of book 12 for turning the pages sequentially. A movable scanning assembly 24 is movable from a first end 20 to a second end 26 of apparatus 10 for scanning the contents of two open pages of book 12.

Book 12 is supported on book-receiving surface 16 and is held in a fixed position by a first hold down gripper 28 located near first end 20 and a second hold down gripper 29 located near second end 26. Grippers 28, 29 are mechanized or automated grippers that hold the pages of book 12 in a fixed position when applied. As will be described in more detail below, through coordinated control of grippers 28, 29, page lifter 18, and scanning assembly 24, page lifter 18 is able to lift a top page of book 12, and scanning assembly 24 moves across book 12 completing turning of the top page, while simultaneously scanning the page underneath the top page being turned and then scanning the reverse side of the page being turned. Further, book-receiving surface 16 has a characteristic of a plane in the preferred embodiment, but may also be in other shapes and forms, such as slightly V-shaped toward the center of apparatus 10, so that a book does not have to be fully opened for imaging. Further, an optical sensor 30 may be included for sensing the presence of a book on book receiving surface 16.

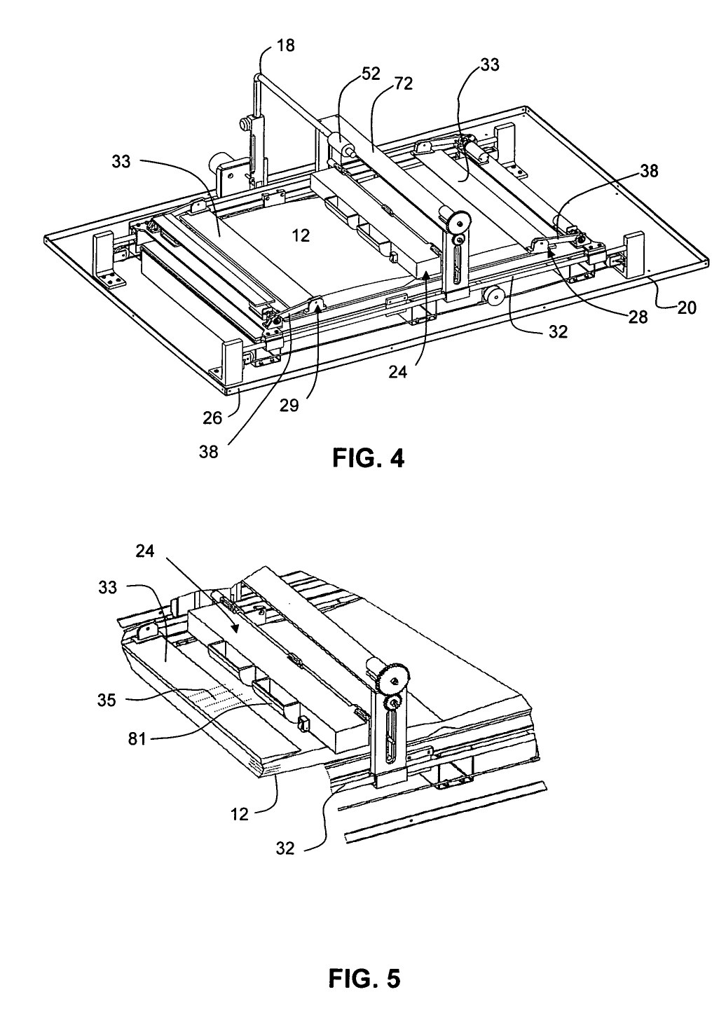

As illustrated in FIG. 2, on the first and second ends 20, 26 of apparatus 10, grippers 28, 29, respectively, are mounted on elongate side rails 32 located on either side of apparatus 10 and which run the length of apparatus 10. Side rails 32 support hold down grippers 28, 29 so that grippers 28, 29 are moveable toward and away from the center of apparatus 10 for accommodating and gripping books of different sizes, while also including sensors for limiting the movement of the scanner apparatus, as will be described in more detail below. Additionally, as also illustrated in FIGS. 4 and 5, grippers 28, 29 may include transparent gripping plates 33 which contact book 12 for holding the pages of book 12 in a fixed position during scanning. Transparent plates 33 may overlay a portion of text or other content 35 on the pages of book 12, but because of their transparency, plates 33 do not prevent scanning of the complete content 35 of each page.

Further, transparent plates 33 of grippers 28 may be coupled to connecting mounts 31 via gripper arms 38. Transparent plates 33 may be moved up and down relative to book 12 by an actuator 39, such as a motor that has the power to lift the grippers 28, 29 upward for loading a book in book-receiving surface 16, and then move grippers 28, 29 downward into an engaged position for contacting and holding the pages of the book in place on surface 16. Grippers 28, 29 incorporate a combination of gripper motor 39 and a spring-biasing mechanism 41 that enables the motor 39 to be cycled on to lift the spring-biased gripper 28, 29 up. Once the gripper has been lifted past a predetermined point, the gripper will stay in the up position, and the motor can be cycled off. Further, when the gripper needs to engage the surface of the book again, the motor 39 is cycled on in the reverse direction, pushing down the gripper to an engaged position. After the position of the gripper passes the predetermined point in the middle, the spring bias of the spring-biasing mechanism 41 will cause the gripper to press down on the book, and the motor 39 can be cycled off again. This system prevents overheating of the motor 39 since the motor does not have to operate during the times that the gripper needs to be stationary, i.e., in the engaged or disengaged position. In alternative embodiments, actuator 39 may be replaced with a thumb screw mechanism for manually tightening grippers 28, 29 against a book, or a simpler spring mechanism for spring-biasing grippers 28, 29 against a book, such as on the edges of the book's cover.

Near the center of apparatus 10 there is located page lifter 18 for lifting pages of the book for turning the pages. Page lifter 18 includes a pivotally-mounted lifting arm 40. Lifting arm 40 may be rotated up and down by a page lifter motor 46, or similar motive means, located adjacent page lifter 18. Mounted on a free end 48 of lifting arm 40 is a page seizer 52. Page seizer 52 in the preferred embodiment includes a layered roll of sticky tape that has an adhesive side facing outward. As the tape loses its adhesiveness through a number of uses, a layer of the tape may be peeled off, revealing a fresh layer of adhesive. In use, page lifter 18 having page seizer 52 functions to lift the top page of the book for turning after that page and its adjacent page have been scanned. The adhesive on page seizer 52 is sufficient to lift the page, and scanning assembly 24 then pushes the page from roller 52, as scanning assembly 24 scans over the surface of the book, thereby completing turning of the page. As the layers of the roller of page seizer 52 are used up, the roller may be replaced with a fresh roller.

In an alternative embodiment, a suction device may act as page seizer 52. The suction device may be cylindrical or other shape, and may be connected to a suction pump via a suction tube running through lifting arm 40. The suction pump may be cycled on to grasp a page of the book, and then cycled off once scanning assembly 24 has begun scanning the next page of the book, thereby releasing the lifted page so that scanning assembly 24 completes turning of the page.

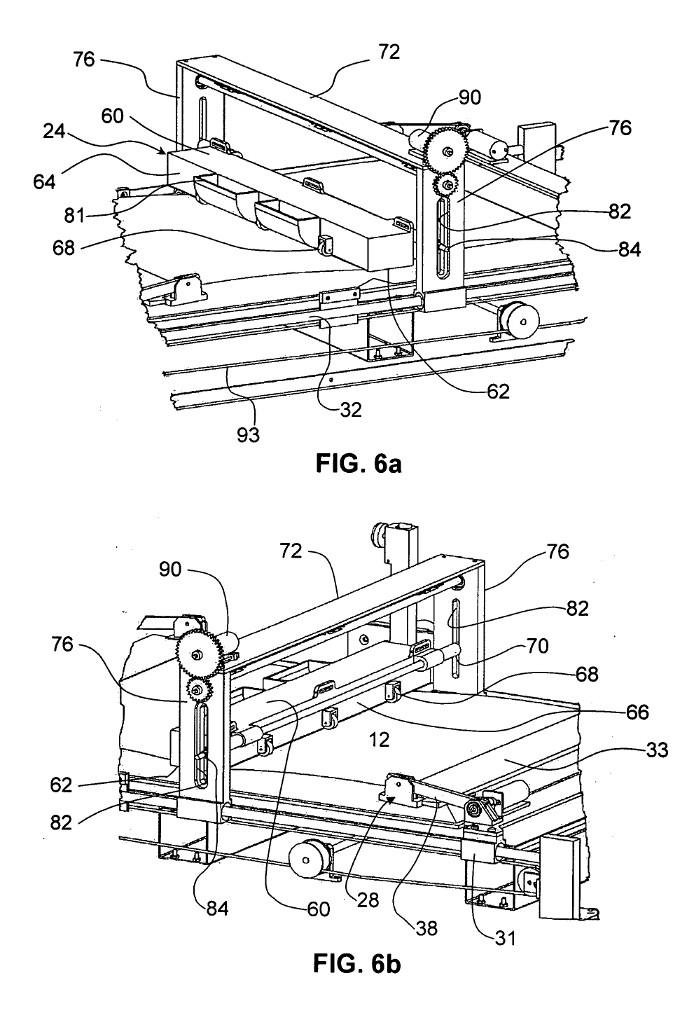

Scanning assembly 24 will now be described. As illustrated in FIGS. 2 and 3, scanning assembly 24 is movable back and forth over a book located within book-receiving surface 16 for acquiring images of the book pages. As also illustrated in FIGS. 6a and 6b, scanning assembly 24 consists of a bar-shaped scanner housing 60, within which is mounted a conventional scanner head 62 including a scanning bulb and image sensors that run the majority of the length of scanning assembly 24. On the outer forward edge 64 and rear edge 66 of scanning assembly 24 there are mounted rollers 68 that support scanning assembly 24 a predetermined distance from a book being scanned, and which enable scanning assembly 24 to move freely back and forth over a book being scanned, while also maintaining scanner scanning head 62 at a desired predetermined distance and position relative to the book being scanned.

Scanning assembly 24 is also supported by a lateral support rod 70, the ends of which are supported in a carriage 72. Carriage 72 is mounted for back and forth motion on the same elongate side rails 32 as grippers 28, 29. Thus, the position of grippers 28, 29 can serve to limit the range of movement of carriage 72. As illustrated in FIG. 3, carriage 72 includes upright supports 76 on either end that support scanning assembly 24 for movement in the vertical direction. Each upright support 76 includes a vertical slot 82 having a slider 84 movable in an up-and-down direction mounted therein. Each end 86 of support rod 70 is mounted within slider 84. Thus, slider 84 is restrained to vertical movement in vertical slot 82. By this arrangement, support rod 70, and thereby scanning assembly 24, is able to move up and down vertically within the confines of vertical slots 82, as scanning assembly 24 traverses over the surface of a book, but is restrained from movement in other directions relative to carriage 72. Accordingly, the scanning assembly's own weight keeps scanning assembly 24 in contact with the surface of the book, while the rollers 68 keep the scanner 62 positioned at the desired distance and attitude with respect to the page for proper scanning and movement of the scanning assembly. Further, scanner housing 60 includes page-contact portions 81 on forward edge 64. Page contact portions 81 have a curved surface for contacting a page being turned to increase the smoothness of the turning action and to prevent possible creasing or tearing of the page. Preferably, page-contact portions 81 have a curved quarter-cylindrical surface that forms a smooth transition surface to the underside of the scanner housing 60 for contacting and turning a page. Additionally, a retraction motor 90 is included on carriage 72 for lifting scanning assembly 24 in an up position during a return function.

Carriage 72 may be driven back and forth along side rails 32 by a belt, chain, or other driver 93, which in turn is driven by a scanning motor 92, or the like, the location of which is illustrated in FIG. 3. The activation and coordination of gripper motors 39, scanning motor 92, page lifter motor 46, and retraction motor 90 is controlled according to software processed by either an on-board processor, or by information processing device 104 in communication with apparatus 10, as discussed above.

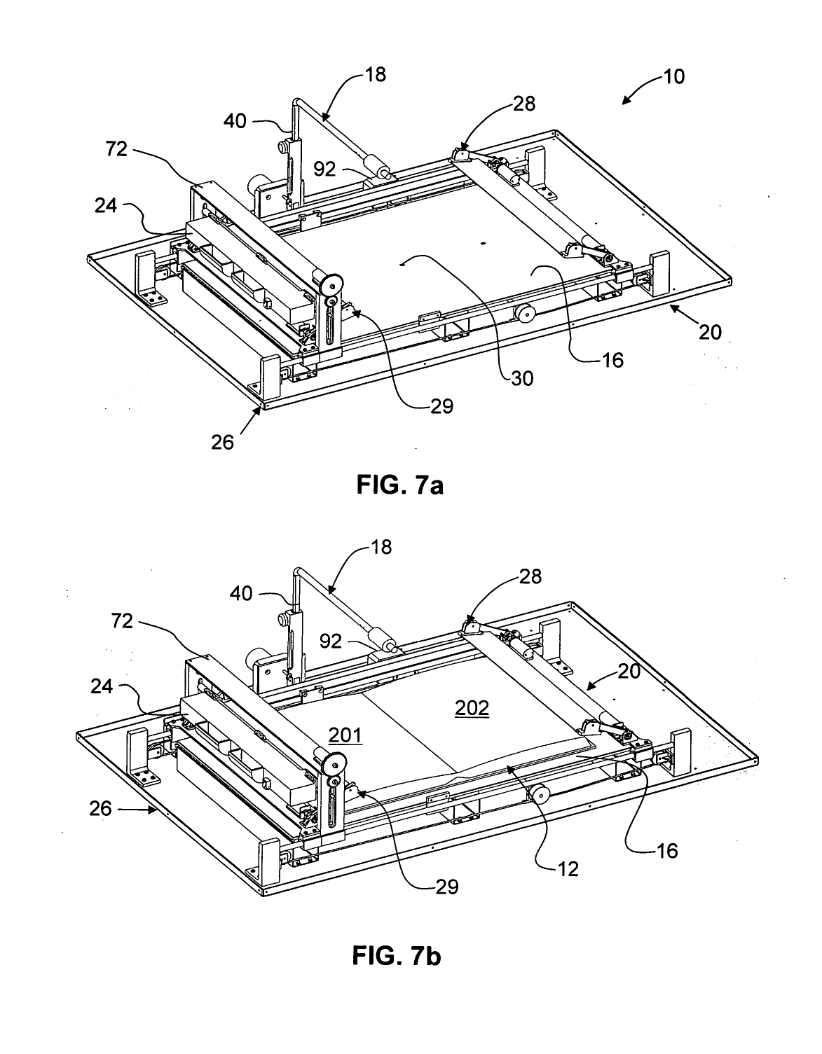

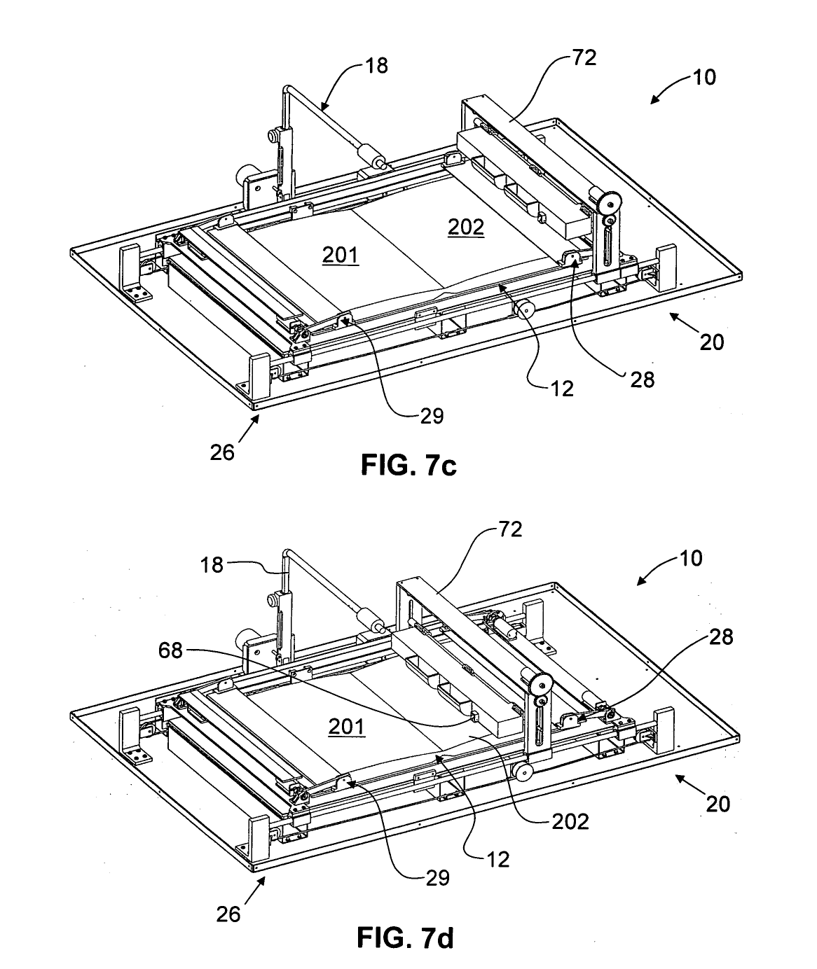

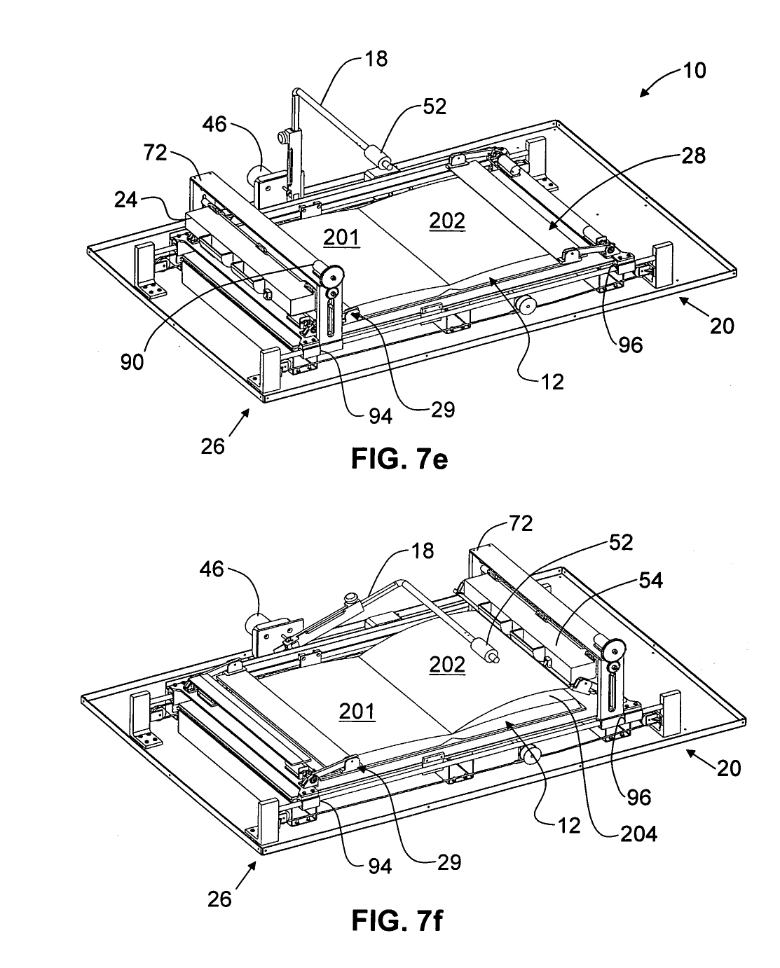

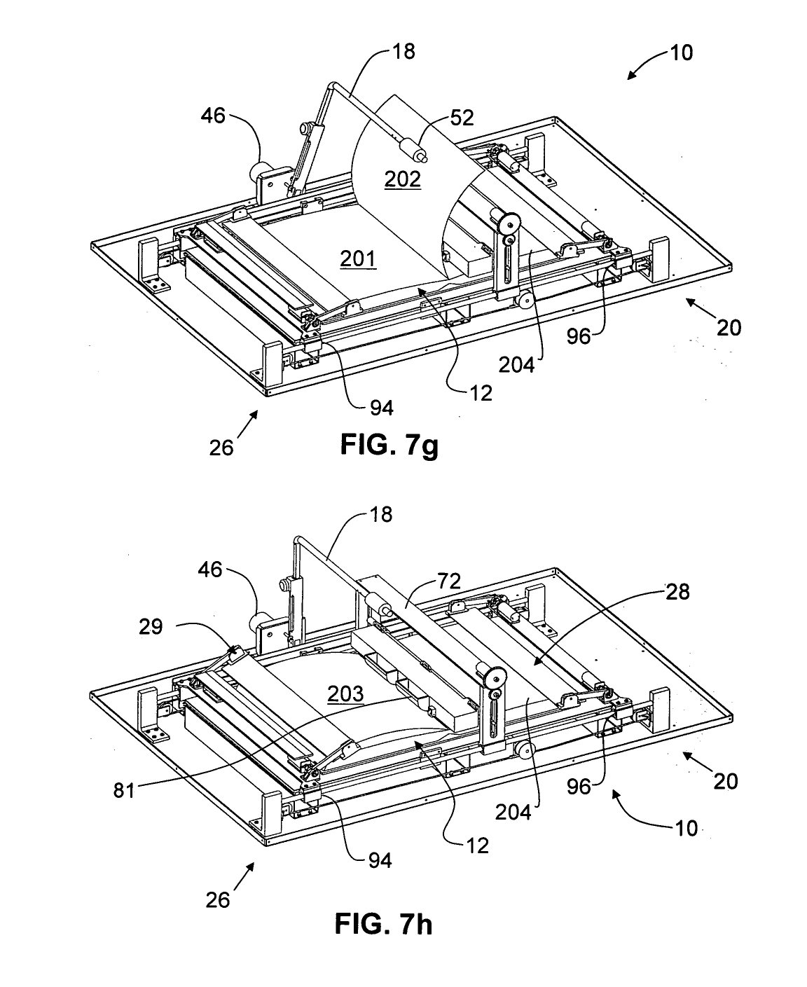

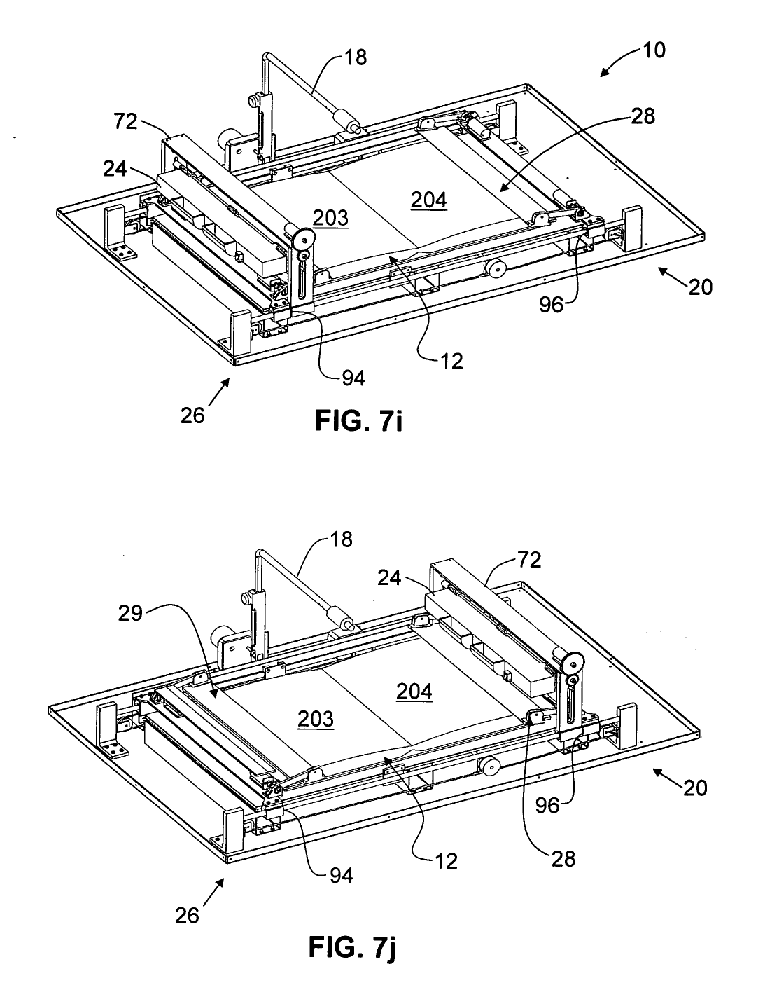

The basic mode of operation of the invention will be described with reference to FIGS. 7a-7h. In operation, for placement of book 12 into book-receiving surface 16, page lifter 18 is positioned so that lifting arm 40 is raised and so that grippers 28, 29 are also raised, as illustrated in FIG. 7a, to enable placement of book 12 in book-receiving surface 16. Also, scanning assembly 24 is located at either first end 20 or second end 26 of apparatus 10. As illustrated in FIG. 7b, book 12 may then be placed on book surface 16, opened to the first two pages to be scanned, designated as page one 201 and page two 202. Next, as illustrated in FIG. 7c, the position of hold down grippers 28, 29 are adjusted longitudinally along bars 32, toward or away from the center of book surface 16 so that grippers 28, 29 are located so as to be able to press down on the opened pages 201, 202 of book 12, thereby holding book 12 in place in book-receiving surface 16, and also preventing pages 201, 202 from moving during scanning. It may be seen that grippers 28, 29 may be moved longitudinally inward or outward relative to the center of book-receiving surface 16 for accommodating a large variety of book sizes. Additionally, scanning assembly 24 is moved to the starting position at first end 20 if it is not already there.

Next, scanning head 62 is energized and scanning motor 92 is activated to move carriage 72 and scanning assembly 24 from first end 20 to second end 26, as illustrated in FIG. 7d. As scanning assembly 24 passes over the second and first pages 202, 201 of book 12, scanning assembly 24 rides on rollers 68 over the surface of pages 202, 201 while being also suspended for free vertical movement within slots 82 in carriage 72. Thus, scanning assembly 24 follows the contour of the book 12 for creating an accurate scan of page two 202 and page one 201. Because of the design of scanning assembly 24, having rollers 68 on the front and rear, scanner 62 remains stable, with no flipping, while keeping the reception the of scanned image nearly perpendicular to the pages of book 12 at all times. Further, because grippers 28, 29 include transparent plates 33, grippers 28, 29 do not interfere with the image-obtaining scanning process, even if a portion of the content of the pages being scanned is covered by the grippers 28, 29.

As illustrated in FIG. 7e, once scanning assembly 24 passes over the whole surface of book 12 and reaches second end 26 of apparatus 10, a sensor 94, such as a limit switch, is reached which causes scanning assembly 24 to be raised up within carriage 72 by activation of retraction motor 90, and held in position above the surface of book 12. Then the scanning motor 92 moves carriage 72 and scanning assembly 24 back to the original starting position at first end 20, as previously illustrated in FIG. 7c, where a sensor 96, such as a limit switch, stops movement of carriage 72. Thus, as the scanning assembly 24 returns to first end 20 of apparatus 10, scanning assembly 24 is again ready for the next pass. Further, it may be seen that through the use of sensors 94, 96 mounted on grippers 28, 29, such as on gripper connecting mounts 31, the range of motion of carriage 72 and scanning assembling 24 is effectively limited by the location of grippers 28, 29. Further, in an alternative embodiment, grippers 28, 29 may be eliminated and/or sensors 94, 96 may be mounted separately from grippers 28, 29, and moveable toward and away from the center of apparatus 10 and/or book 12 for serving to limit the range of movement of scanning apparatus 24 to a particular book size. For example, a single sensor might be moveable toward and away from a first edge of book 12, while the second edge of book 12 is adjacent to a position of scanning assembly 24. In another arrangement, grippers 28, 29 may be eliminated with the exception of connecting mounts 31, and sensors 94, 96 are mounted on connecting mounts 31 for movement toward and away from the center of apparatus 10 for limiting the movement of scanning assembly 10. Other arrangements for moveable sensors 94, 96 will also be apparent, wherein sensors 94, 96 are adjusted to serve to limit the range of movement of scanning assembly 24.

Next, as illustrated in FIG. 7f, to scan the next two pages of book 12, first gripper 28 on first end 20 is raised, and page lifter 18 is activated by page lifter motor 46, which moves page lifter 18 down toward book 12 so that page seizer 52 contacts page two 202, as illustrated in FIG. 7f. Page lifter 18 is then moved in the opposite direction, lifting page two 202 to create an open space between that page and page four 204 located underneath that page. As this occurs, first gripper 28 is moved back down to contact and clamp page four 204 in place and page lifter 18 continues to rise upward. Thus, under the design of the invention, it is possible for first gripper 28 to hold page four 204 in place prior to the start of scanning page four 204, and because first gripper 28 incorporates transparent plate 33, it does not matter if a portion of the content of page four 204 is covered by gripper 28. Next, scanning motor 92 is activated and scanning assembly 24 passes over and scans page four 204, by moving in the space created between the lifted page and page four 204. While page lifter 18 rises up the rest of the way back to a near vertical position, scanning assembly 24 and carriage 72 contact the rear side of page two 202 (i.e., page three 203), and pushes against this page, as illustrated in FIG. 7g. Also, second gripper 29 at second end 26 is raised to make way for the page being turned.

As carriage 72 and scanning assembly 24 push against page two/three, this causes page two/three to complete the turning process by flipping the rest of the way over, so that page three 203 is now open and scanning assembly 24 is able to pass over and scan page three 203 (i.e., the reverse side of page two 202, as illustrated in FIG. 7h, with page contact portions 81 providing a smooth transition surface. Second gripper 29 then moves back down to contact and restrain page three 203, and scanning assembly 24 passes over the remainder of page three 203 and second gripper 29. As illustrated in FIG. 7i, when scanning assembly 24 reaches sensor 94, the scanner is again raised as described above and returned to the starting position illustrated in FIG. 7j, where page lifter 18 may proceed to page four 204 for turning. Thus, it may be seen that the process may be repeated continuously for sequentially acquiring images of any number of desired pages of book 12.

As discussed above, the sequence of operation of the various components is controlled by a controller either on board apparatus 10, or in information processing device 104. Thus, the settings can be configured as desired before or after the operations begin. The controller controls all parts of automatic book scanning apparatus 10 and makes them work and operate in automated fashion. The scanned images may be sorted and reproduced in an electronic format (or a computer file) by assembling the images in a correct sequence, position and side that resembles the original. Thus, the apparatus of the invention is able to automatically copy a book without requiring constant supervision and interference from a person, and can create an output in an electronic format.

While specific embodiments have been illustrated and described in this specification, those of ordinary skill in the art will appreciate that any arrangement that is calculated to achieve the same purpose may be substituted for the specific embodiments disclosed. This disclosure is intended to cover any and all adaptations or variations of the present invention, and it is to be understood that the above description has been made in an illustrative fashion, and not a restrictive one. Accordingly, the scope of the invention should properly be determined with reference to the appended claims, along with the full range of equivalents to which such claims are entitled.

What is claimed is:

1. An apparatus for acquiring images of sequential pages of a book, comprising:
a book-receiving surface for receiving the book;
a carriage for moving a scanner over opened pages of the book for acquiring said images;
one or more sensors moveable toward and away from a center of said book, said one or more sensors serving to limit the movement of the carriage, for adjusting to books of various sizes based upon the location of said one or more sensors.

2. The apparatus of claim 1 further including
first and second grippers for holding said opened pages of said book in a fixed position, said grippers having slideable connecting mounts and being movable toward and away from the center of said book, said one or more sensors being mounted on said first and second grippers or said connecting mounts.

3. The apparatus of claim 1 further including
at least one gripper for holding said opened pages of said book in a fixed position, wherein said at least one gripper includes a transparent plate for contacting at least one of said opened pages, while said scanner is able to scan said opened page an acquire an image of said opened page including any content covered by the transparent plate.

4. The apparatus of claim 1 further including
a page lifter for lifting a first page of said book for turning the first page, wherein said scanner or said carriage contacts the first page that has been lifted and completes turning of the lifted page.

5. A system for scanning multiple pages of a book, the system comprising:
a book receiving surface for receiving a book in an opened position;
a movable scanner for scanning opened pages of the book;
a first transparent gripper for holding a first opened page of the book in a fixed position for scanning;
wherein the scanner moves over the gripper and the first opened page underneath the gripper, for obtaining an electronic image of the first opened page of the book.

6. The system of claim 5 further including
a second transparent gripper for holding a second opened page of the book in a fixed position, wherein the scanner moves over the second opened page and the second transparent gripper during scanning of the second opened page, following scanning of the first opened page.

7. The system of claim 6 further including
a page lifter for lifting the first opened page of the book for turning the first page, wherein the scanner pushes against the lifted first page for completing turning of the lifted first page following lifting by the page lifter.

8. The system of claim 5 further including
one or more sensors moveable toward and away from a center of the book receiving surface for limiting the movement of the scanner, whereby the movement of the scanner is limited by the one or more sensors according to placement of the one or more sensors based on the size of the book.

9. The system of claim 7 further including
a bar-shaped scanner housing containing the scanner, said scanner housing including one or more page contact portions on a forward edge, said one or more page contact portions forming a smooth transition surface to the underside of the scanner housing.

10. The system of claim 9 further including
a spring biasing means for urging said grippers into engagement with said pages of said book, and a motive means for moving said grippers out of engagement with said pages of said book.

11. The system of claim 10 further including
rollers on said scanner housing for enabling said scanner to move over said opened pages of said book, while maintaining said scanner at a predetermined height and position relative to said pages.

12. The system of claim 11 further including
a movable carriage having vertical slots for retaining said scanner housing, said grippers being movable toward and away from a center of said book receiving surface for accommodating books of different sizes, wherein said grippers limit the movement of said carriage.

13. An apparatus for acquiring images of sequential pages of a book, the apparatus comprising:
a book receiving surface for receiving a book in an opened condition;
a scanner moveable over opened pages of the book, for acquiring images thereof; and
a first transparent gripper movable into contact with a first opened page of the book for holding the first opened page in a fixed position during scanning,
a second transparent gripper movable into contact with a second opened page, opposite to the first opened page, for holding the second opened page in a fixed position during scanning,
whereby, when said scanner moves over said opened pages of said book, said scanner is also able to move over said transparent grippers, such that acquired images include a portion of the opened pages underlying the grippers.

14. The apparatus of claim 13 further including
a page lifter for lifting a top page of the book for turning the top page, whereby a first one of said grippers contacting said top page releases contact with said top page to enable said page lifter to lift said top page, and whereby after said top page is lifted, said first gripper moves into contact with a next page located immediately below said top page.

15. The apparatus of claim 14 wherein
the scanner pushes against the lifted first page for completing turning of the lifted first page following lifting by the page lifter.

16. The apparatus of claim 15 further including
a bar-shaped scanner housing containing the scanner, said scanner housing including one or more page contact portions on a forward edge, said one or more page contact portions forming a smooth transition surface to the underside of the scanner housing.

17. The apparatus of claim 16 further including
rollers on said scanner housing for enabling said scanner to move over said opened pages of said book, while maintaining said scanner at a predetermined height and position relative to said pages.

18. The apparatus of claim 13 further including
a spring biasing means for urging said grippers into engagement with said pages of said book, and a motive means for moving said grippers out of engagement with said pages of said book.

19. The apparatus of claim 13 further including
a bar-shaped scanner housing containing the scanner;
a movable carriage having vertical slots for retaining said scanner housing; and
rollers on said scanner housing for enabling said scanner to move over said opened pages of said book, while maintaining said scanner at a predetermined height and position relative to said pages.

20. The apparatus of claim 13 further including
a movable carriage for moving said scanner, and
one or more sensors that are movable toward and away from a center of said book receiving surface for accommodating books of different sizes, and wherein said sensors limit the movement of said carriage.
